(19) United States
(12) Patent Application Publication
(10) Pub. No.: US 2009/0314114 A1
(43) Pub. Date: Dec. 24, 2009

(54) Backlash elimination mechanism for gear systems for low speed applications

(75) Inventor: Julian Joel Grosberg, Even Yehuda (IL)

Correspondence Address: Ronny Fogel;c/o Daltan Consulting Ltd., P.O. Box 1146, Kfar Sava, 44110, IL

(73) Assignee: Elram Engineering and Advanced Technologies 1992 Ltd., Emek Hefer (IL)

(21) Appl. No.: 12/457,529

(22) Filed: Jun. 15, 2009

Related U.S. Application Data
(60) Provisional application No. 61/129,311, filed on Jun. 18, 2008.

(51) Int. Cl. F16H 57/12; F16H 55/18

(52) U.S. Cl. 74/409

(57) ABSTRACT

A zero backlash mechanism for a worm, spur or helical gears, using a spring loaded mechanism that tightens the meshing gear surfaces, thus eliminating the backlash between them.

### CROSS-REFERENCE TO RELATED PATENT APPLICATIONS

This patent application claims priority from and is related to U.S. Provisional Patent Application Ser. No. 61/129,311, filed 18 Jun. 2008, this U.S. Provisional Patent Application incorporated by reference in its entirety herein.

### FIELD OF INVENTION

The invention relates generally to spur, helical or worm gearboxes, and more particularly, to such gearboxes in which the backlash between the gears is eliminated by spring force.

### BACKGROUND OF INVENTION

In the field of drive systems, there exist many types of gear arrangements: helical, spur, bevel, worm and other types.

The driving and driven shafts vary from parallel to vertical arrangements.

Properly functioning mechanical systems need to have a certain clearance/backlash (gap, play) between the components transmitting motion under load.

Clearance is necessary to avoid interference, wear and excessive heat generation, insure proper lubrication, compensate for manufacturing tolerances etc. Clearance in the gear mesh means that the gap between the teeth of one gear is by a small amount larger than the tooth width of the mating gear.

In some applications, especially at low speeds, where high accuracy is needed, for example, in closed loop tracking applications, zero or minimal backlash will enable better functioning of the system. There are many patents for mechanism that reduces or eliminates backlash in various types of gears.

### SUMMARY OF INVENTION

The primary object of the present invention is to overcome the drawbacks caused with other “rigid” or non-flexible solutions of backlash elimination between spur, helical, worm types of gear, especially for low speed, tracking or positioning applications.

This object is achieved by using a spring loaded mechanism that tightens the meshing gear surfaces, thus eliminating the backlash between them. Another object of this invention is to create a repeatable, rotational positioning stage, with virtually zero backlash.

The present invention relates to a backlash eliminating mechanism, comprising a housing with a base portion that acts as a support structure. The present invention is a simple, reliable and low-cost solution, applicable especially for low-speed systems.

At the same time, the system has automatic compensation for wear of materials, hence re-adjustment is automatically achieved.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1A and 1B show a schematic construction of the worm gearbox internal parts of the invention, illustrating the backlash elimination mechanism applied to the driving element; and

FIGS. 2A and 2B show a schematic construction of the spur (or helical) gearbox internal parts of the invention, illustrating the backlash elimination mechanism applied to the driving element.

### DETAILED DESCRIPTION OF PREFERRED EMBODIMENTS

The present invention provides a drive system used particularly (but not only) in low-speed tracking or positioning systems or applications.

For Worm Sear Systems:

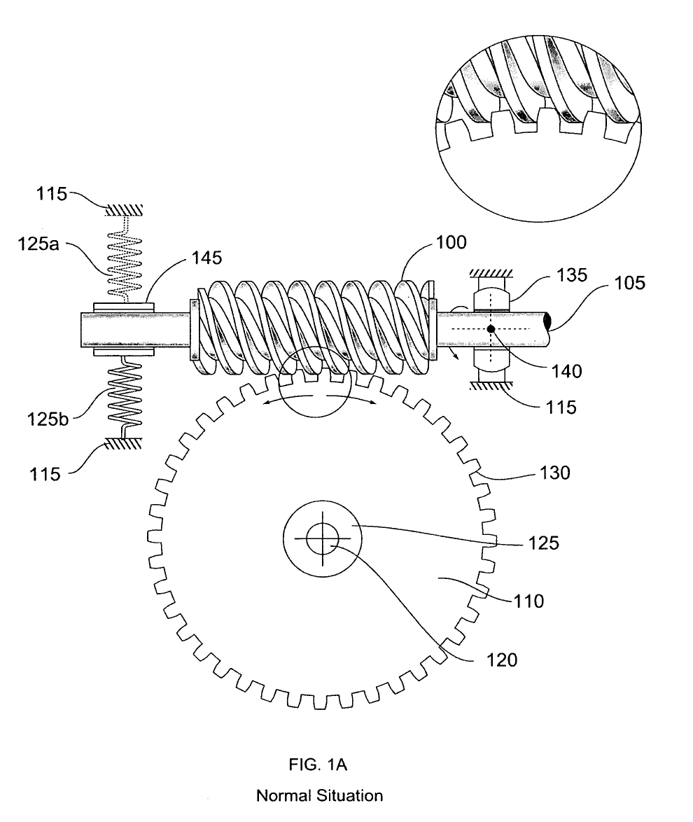

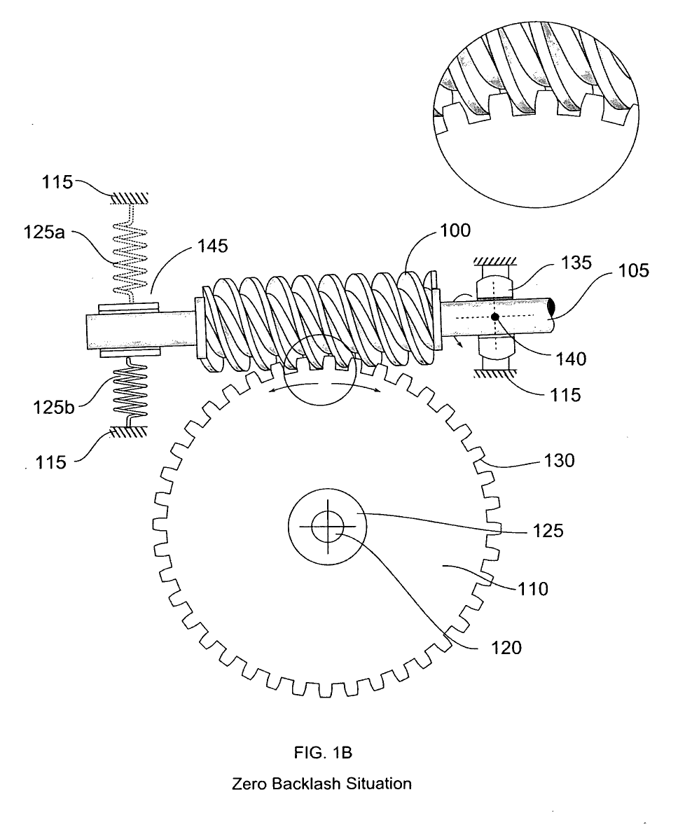

FIGS. 1A and 1B depict a first embodiment of the present system for backlash elimination.

The system includes a driving (input) element (100) that is a worm pinion assembled on a shaft (105), or a combined wormshaft (100+105).

A driven element (110), a worm gear, rotates inside housing (115), around shaft (120), fixed in the housing by bearings (125).

The pinion (100) is usually a low speed element, a motor or a gear motor, or any other rotating element.

A compression spring (125a) or an extension spring (125b) (or other types of springs that cause similar effect) is fixed to the housing (115) on one end and connected to the shaft (105) through sliding (or other type) of bearing (145), or even directly wrapped around the shaft (105) with the ability to slide on it, tightening the pinion (100) and gear flanks (130) towards each other, thus eliminating the natural backlash of a normal worm gear set. The springs can be fixed or adjustable.

The shaft (105) is fixed to the internal part of a spherical (or other type) bearing (135), and is rotatable around its axis, but at the same time can have a small degree of freedom around the bearing center (140), to allow the backlash closing effect.

As a result, the backlash between driving element (100) and driven element (110) is eliminated (FIG. 1B).

The motor or gear motor that rotates shaft (105) must be rigidly mounted on shaft (105), or otherwise connected through a flexible element to shaft (105).

For Spur or Helical Gear System:

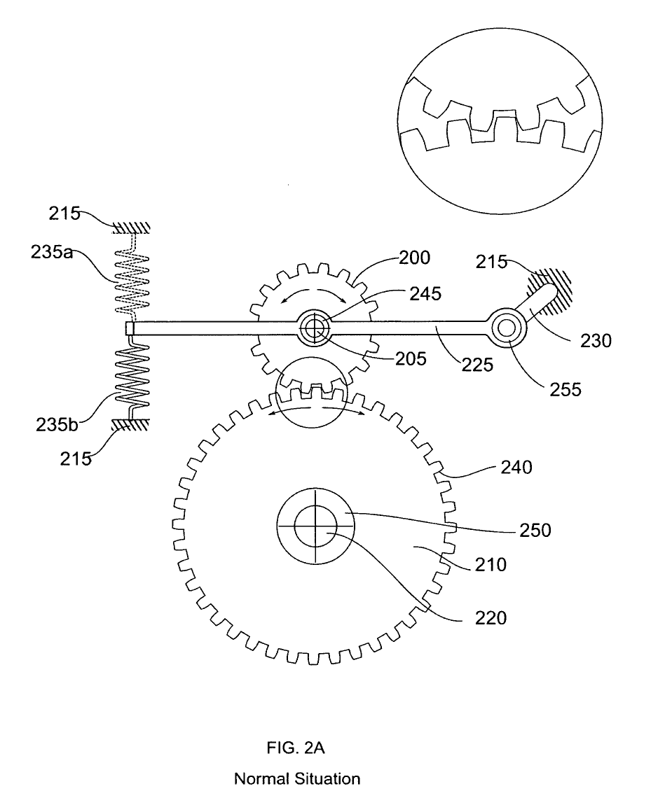

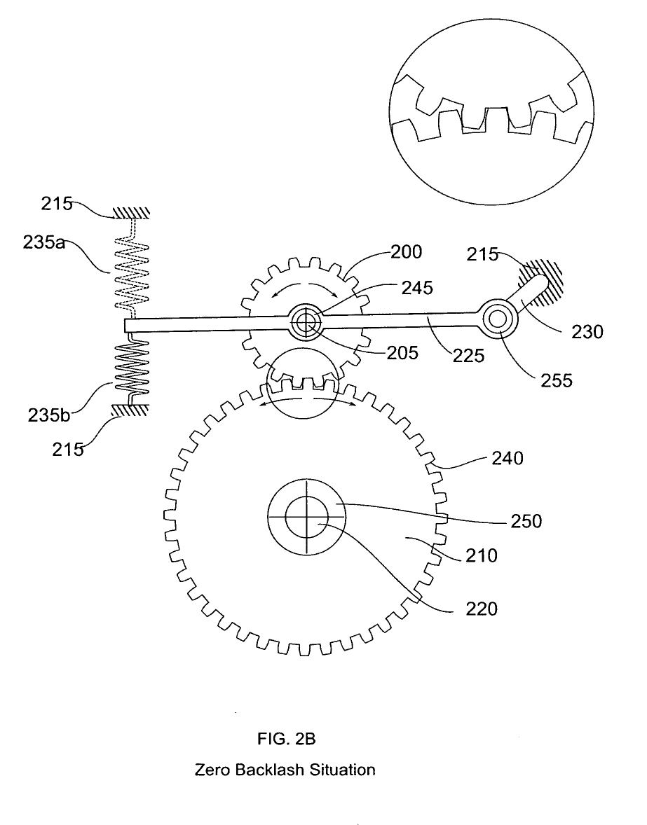

FIGS. 2A and 2B depict a second embodiment of the present system for backlash elimination.

The system includes a driving (input) element (200) that is a spur or helical gear (pinion) assembled on a shaft (205), or a combined gear+shaft (200+205). The driving element (200) rotates around shaft (205) by sliding or any type of bearings (245).

A driven element (210), a spur or helical gear, rotates inside a housing (215), around shaft (220) that is held by bearings (250).

The pinion (200) is usually a low speed element driven by a low speed motor or gearmotor, or any other rotating element.

A lever (225) carries the shaft (205) and is rotatable around the axis of shaft (230) through sliding (or other) bearing (255), enabling the lever (225) a small rotation angle around the axis of shaft (230).

A compression spring (235a) or an extension spring (235b) (or a torsion spring connected to shaft (230), that causes a similar effect) tightens the gears towards each other, thus eliminating the natural backlash of a regular spur or helical gear set. The springs can be fixed or adjustable.

The spring (235a or 235b), extension or compression of any other type, is connected at one end to the housing (215) and on the other side to the lever (225).

In an alternative embodiment, shaft (230) may be rigidly connected to the lever (225), in which case the lever (225) acts as a tension spring and the spring (235a or 235b) are not needed.

As a result, the backlash between driving element (200) and driven element (210) is eliminated (FIG. 2B).

The motor or gearmotor that rotates pinion (200) must be rigidly mounted on shaft (205), or otherwise connected through a flexible element to shaft (205).

The springs, in all the embodiments described above, may be at fixed preloaded, push or pull type, but also with an option of adjusting the push or pull force by changing the preloads, (for example, changeable tensioning or compressing the springs).

The invention may be embodied in other specific forms without departing from the spirit or essential characteristics thereof. The present embodiments are therefore to be considered in all respects as illustrative and not as restrictive, the scope of the invention being indicated by the appended claims rather than by the foregoing description, and all changes which come within the meaning and range of equivalency of the claims are therefore intended to be embraced therein.

The system according to the present invention has the additional advantage of automatically compensating for wear of materials, which has the effect of increasing the backlash effect in standard systems.

1. A zero backlash mechanism for a worm gear, comprising:
a housing;
a driving worm pinion assembled on a first shaft, said first shaft fixed on one side thereof to the internal side of a first bearing and rotatable around its axis inside said first bearing, wherein said shaft has a degree of freedom inside said first bearing and wherein said first bearing is fixed to the housing;
a driven worm gear assembled on a second shaft and rotatable around said second shaft through a second bearing, wherein said second shaft is fixed to the housing;
a spring connected to said first shaft, said spring fixed on its other end to the housing;
said spring operable to tighten the driving gear and the driven gear towards each other.

2. The mechanism of claim 1, wherein said bearings are sliding bearings.

3. The mechanism of claim 1, wherein said spring is a compression spring.

4. The mechanism of claim 1, wherein said spring is an extension spring.

5. The mechanism of claim 1, wherein said spring is fixed.

6. The mechanism of claim 1, wherein said spring is adjustable.

7. A zero backlash mechanism for spur or helical gears, comprising:
a housing;
a driving gear assembled on a first shaft, said driving gear being one of spur and helical and rotatable around said first shaft through a first bearing, said driving element driven by one of a low-speed motor and a low-speed gearmotor;
a driven gear assembled on a second shaft, said driven gear being one of spur and helical and rotatable around said second shaft through a second bearing, wherein said second shaft is fixed to the housing;
a lever connected to a third shaft, said third shaft fixed to the housing, said lever rotatable around said third shaft through a third bearing, said lever connected to one end of a spring, wherein the other end of said spring is fixed to the housing and wherein said first shaft is carried by said lever;
said spring operable to tighten the driving gear and the driven gear towards each other.

8. The mechanism of claim 7, wherein said bearings are sliding bearings.

9. The mechanism of claim 7, wherein said spring is a compression spring.

10. The mechanism of claim 7, wherein said spring is an extension spring.

11. The mechanism of claim 7, wherein said spring is fixed.

12. The mechanism of claim 7, wherein said spring is adjustable.

13. A zero backlash mechanism for spur or helical gears, comprising
a housing;
a driving gear assembled on a first shaft, said driving gear being one of spur and helical and rotatable around said first shaft through a first bearing, said driving element driven by one of a low-speed motor and a low-speed gearmotor;
a driven gear assembled on a second shaft, said driven gear being one of spur and helical and rotatable around said second shaft through a second bearing, wherein said second shaft is fixed to the housing;
a lever rigidly connected on one side thereof to a third shaft, said third shaft fixed to the housing, wherein said first shaft is carried by said lever;
said lever operable to tighten the driving gear and the driven gear towards each other.
